(19) United States
(12) Patent Application Publication
(10) Pub. No.: US 2025/0232649 A1
(43) Pub. Date: Jul. 17, 2025

(54) AUTOMATED TELLER MACHINE

(71) Applicant: Hitachi Channel Solutions, Corp., Tokyo (JP)

(72) Inventors: Yukinobu OKADA, Tokyo (JP); Bijaya Ram SHRESTHA, Tokyo (JP); Atsushi NINOMIYA, Tokyo (JP); Katsumi USAMI, Tokyo (JP)

(73) Assignee: Hitachi Channel Solutions, Corp., Tokyo (JP)

(21) Appl. No.: 19/016,922

(22) Filed: Jan. 10, 2025

(30) Foreign Application Priority Data
Jan. 12, 2024 (JP) 2024-003337

(51) Int. Cl. G07F 19/00

(52) U.S. Cl. CPC G07F 19/207; G07F 19/201

(57) ABSTRACT

An automated teller machine includes an apparatus main unit, a screen display unit that is provided to the apparatus main unit, a plurality of mirror portions that are provided on a periphery of the screen display unit, a first light portion that is provided in a predetermined area of an outer edge of each of the mirror portions, and a control unit that is provided to the apparatus main unit. The control unit is configured to control lighting of the first light portion in accordance with an environment of the apparatus main unit.

### BACKGROUND

The present invention relates to an automated teller machine.

Users can perform transactions such as deposits, withdrawals, and so forth, using automated teller machines such as automatic teller machines (ATM: Automatic Teller Machine) installed in various types of facilities, such as airports, train stations, banks, hotels, convenience stores, and so forth (Japanese Patent No. 5278515, Japanese Patent Application Publication No. 2004-178467, Japanese Patent Application Publication No. H08-249548). Note that JP Design Registration No. 1689770 is known as an example of an external appearance of an ATM.

### SUMMARY OF THE INVENTION

There is room for improvement with automated teller machines according to conventional technology, with respect to the point of crime prevention capabilities.

The present invention has been made to solve the above problem, and an object thereof is to provide an automated teller machine in which crime prevention capabilities can be improved.

In order to solve the above problem, an automated teller machine according to the present invention includes an apparatus main unit, a screen display unit that is provided to the apparatus main unit, a plurality of mirror portions that are provided on a periphery of the screen display unit, a first light portion that is provided in a predetermined area of an outer edge of each of the mirror portions, and a control unit that is provided to the apparatus main unit. The control unit is configured to control lighting of the first light portion in accordance with an environment of the apparatus main unit.

According to the present invention, a user can confirm a situation behind him/herself through the mirror portion, and further, the control unit can control lighting of the first light portion that is provided to the mirror portions on the periphery of the screen display unit, in accordance with the environment of the apparatus main unit.

### BRIEF DESCRIPTION OF THE DRAWINGS

FIG. 1 is an external perspective view illustrating a part of an automated teller machine;

FIG. 2 is a frontal view, a left-side view, a right-side view, and a plan view, of the automated teller machine;

FIG. 3 is an explanatory diagram that schematically illustrates a relation between a screen display unit and mirror portions on the periphery thereof;

FIG. 4 is an explanatory diagram illustrating a configuration of the mirror portions;

FIG. 5 is an explanatory diagram illustrating a modification of the mirror portions;

FIG. 6 is an explanatory diagram illustrating another modification of the mirror portions;

FIG. 7 is a block diagram illustrating an electrical configuration of the automated teller machine;

FIG. 8 is a flowchart showing control processing of the automated teller machine;

FIG. 9 is a flowchart showing control processing of an automated teller machine according to a second embodiment;

FIG. 10 is a flowchart showing control processing of an automated teller machine according to a third embodiment;

FIG. 11 is an explanatory diagram of displaying video that is shot by a camera portion on a screen display unit;

FIG. 12 is a flowchart showing control processing of an automated teller machine according to a fourth embodiment;

FIG. 13 is a flowchart showing control processing of an automated teller machine according to a fifth embodiment;

FIG. 14 is a flowchart showing control processing of an automated teller machine according to a sixth embodiment;

FIG. 15 is a flowchart showing control processing of an automated teller machine according to a seventh embodiment;

FIG. 16 is an external perspective view illustrating part of an automated teller machine according to an eighth embodiment;

FIG. 17 is an external perspective view with partition portions in FIG. 16 removed;

FIG. 18 is an external perspective view illustrating part of an automated teller machine according to a ninth embodiment;

FIG. 19 is a flowchart showing control processing of an automated teller machine according to a tenth embodiment;

FIG. 20 is a flowchart showing control processing of an automated teller machine according to an eleventh embodiment; and

FIG. 21 is a flowchart showing control processing of an automated teller machine according to a twelfth embodiment.

### DETAILED DESCRIPTION OF THE EMBODIMENT

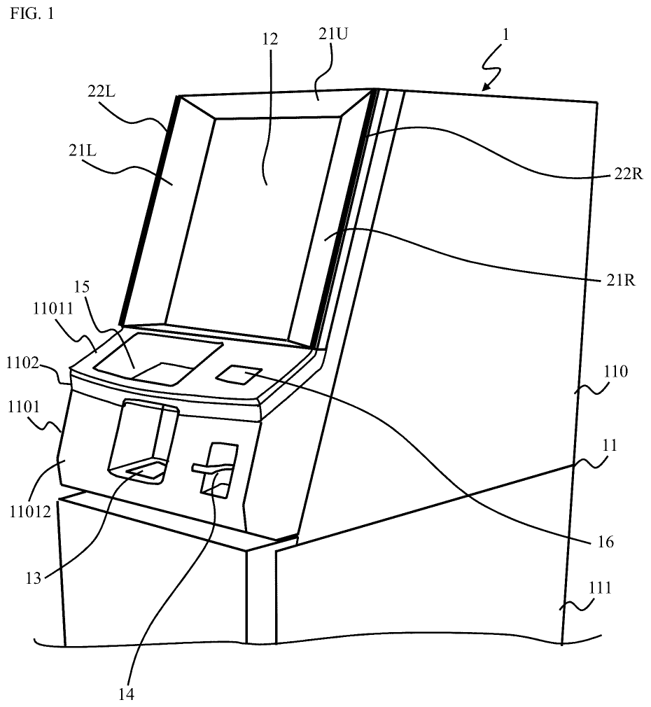

Embodiments of the present invention will be described below with reference to the drawings. An automated teller machine 1 according to the present embodiment includes a plurality of mirror portions 21L and 21R provided on a periphery of a screen display unit 12, first light portions 22L and 22R that are provided to a predetermined area on an outer edge of each of the mirror portions, and a control unit that is provided in an apparatus main unit, which will be described later with reference to FIG. 1 and subsequent drawings. The control unit controls lighting of the first light portions in accordance with the environment of the apparatus main unit. Accordingly, a user operating the automated teller machine can confirm the situation behind his/her back via the mirror portions. The control unit controls lighting of the first light portions in accordance with the environment of the apparatus main unit, and accordingly, in a case of detecting a suspicious person behind the user, or the like, can light the first light portions and call the attention of the user, warn the suspicious person, or the like.

### First Embodiment

A first embodiment will be described with reference to FIGS. 1 to 8. In the present embodiment, an ATM 1 will be exemplarily described as the automated teller machine 1. In the drawings, the automated teller machine 1 is illustrated as the ATM 1.

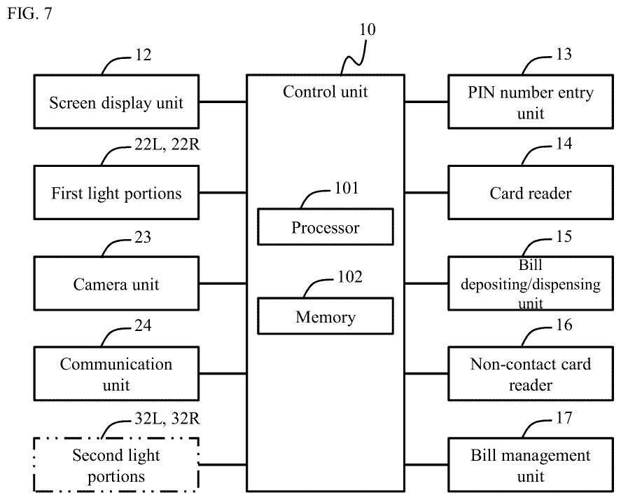

The ATM 1 is an apparatus that executes various types of transactions, such as depositing transactions and withdrawal transactions of bills and coins, by operations performed by a user. The ATM 1 includes, for example, a control unit 10 (see FIG. 7), an ATM main unit 11 serving as an apparatus main unit, a screen display unit 12, a PIN number entry unit 13, a card reader 14, a bill depositing/dispensing unit 15, a non-contact card reader 16, a bill management unit 17 (see FIG. 7), mirror portions 21L, 21R, and 21U, the first light portions 22L and 22R, a camera unit 23, and a communication unit 24 (see FIG. 7), which will each be described later.

The apparatus main unit 11 includes an upper structure 110 in which the control unit 10 and so forth are built in, and a lower structure 111 in which the bill management unit 17 and so forth are built in. The screen display unit 12 is disposed at a front face of the upper structure 110. In the upper structure 110, an operating area 1101 is formed protruding forward on a lower side of the screen display unit 12. Units 13 to 16 that are operated by the user are disposed in the operating area 1101. These units 13 to 16 may be collectively referred to as an operating unit.

The operating area 1101 is formed substantially trapezoidal overall, as viewed from the side. The operating area 1101 includes an upper face portion 11011 that is situated on the upper side and slightly inclines downward from a horizontal orientation, and a front face portion 11012 that is integrally formed extending downward from a front end of the upper face portion 11011. A stepped portion 1102 is integrally formed at a boundary at which the upper face portion 11011 and the front face portion 11012 connect.

Disposed on the upper face portion 11011 of the operating area 1101 are, for example, the bill depositing/dispensing unit 15, and the non-contact card reader 16 that is situated next to the bill depositing/dispensing unit 15. Disposed on the front face portion 11012 of the operating area 1101 are, for example, the PIN number entry unit 13, and the card reader 14 that is situated next to the PIN number entry unit 13. The PIN number entry unit 13 is situated on a lower side of the bill depositing/dispensing unit 15, and the card reader 14 is situated on a lower side of the non-contact card reader 16.

The stepped portion 1102 clearly differentiates between the upper face portion 11011 where the bill depositing/dispensing unit 15 and the non-contact card reader 16 are disposed, and the front face portion 11012 where the PIN number entry unit 13 and the card reader 14 are disposed, and guides user operations from the lower side toward the upper side.

The mirror portions 21L, 21R, and 21U are provided on the periphery of the screen display unit 12. The mirror portion 21L is provided on a left side of the screen display unit 12, the mirror portion 21R is provided on a right side of the screen display unit 12, and the mirror portion 21U is provided on an upper side of the screen display unit 12, respectively. The mirror portions 21L and 21R are formed extending in an elongated manner from an upper end to a lower end of the screen display unit 12. A role of improved crime prevention capabilities and a role of a threefold mirror can be provided for users who are of lower stature, due to age, using a wheelchair, or the like.

The right and left mirror portions 21L and 21R of the screen display unit 12 are providing inclined forward from a plane parallel to the screen display unit 12, and the first light portions 22L and 22R are provided in predetermined areas on the outer edge thereof. The mirror portion 21U on the upper side of the screen display unit 12 is provided so as to be flush with the screen display unit 12. In this example, no first light portion is provided to the mirror portion 21U, but a first light portion may be provided to the mirror portion 21U. The predetermined areas on the outer edges of the mirror portions 21L and 21R may be an entire range from the upper ends to the lower ends of the mirror portions 21L and 21R, as illustrated in FIG. 1 for example, or may be part of the range from the upper ends to the lower ends thereof.

Note that while directions of right-left and up-down are used in the present embodiment in order to facilitate understanding, but alternatively, for example, a leftward direction may be referred to as a first direction, a rightward direction as a second direction, an upward direction as a third direction, a downward direction as a fourth direction, a forward direction as a fifth direction, and a rearward direction as a sixth direction.

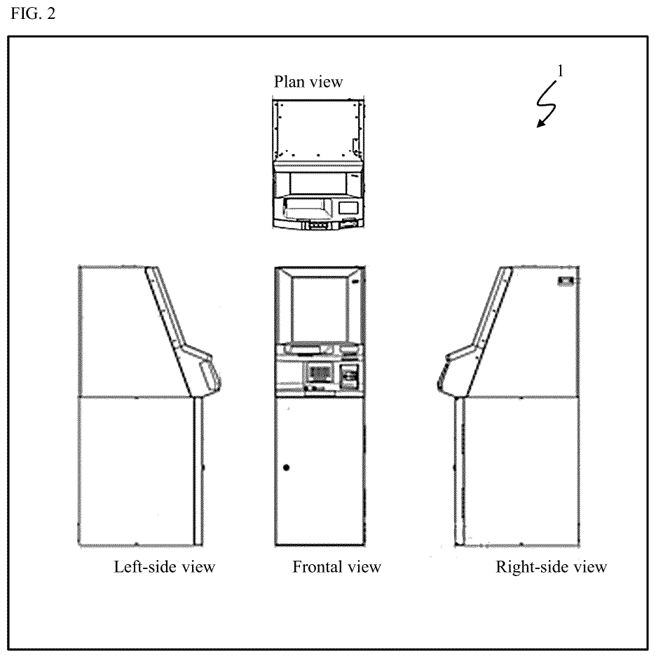

FIG. 2 is a frontal view, a left-side view, a right-side view, and a plan view, of the ATM 1. A bottom view and a rear view are omitted.

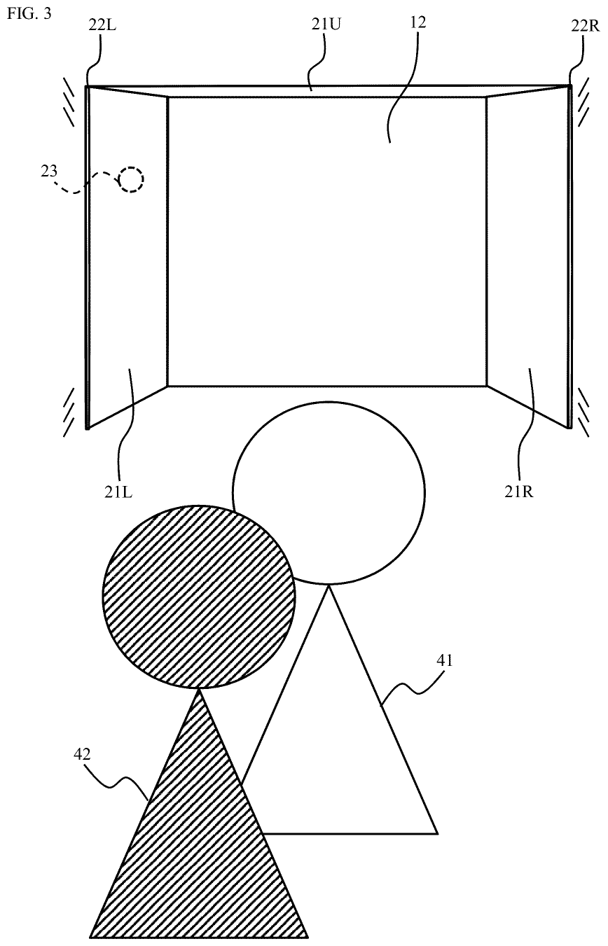

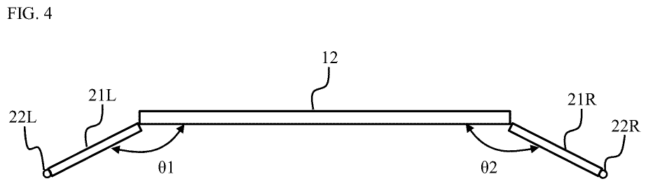

FIG. 3 schematically illustrates a relation between the screen display unit 12 and the mirror portions on the periphery thereof. FIG. 4 illustrates a configuration of the mirror portions. The mirror portion 21U on the upper side is omitted from illustration in FIG. 4.

As described above, the mirror portions 21L and 21R are disposed inclined forward on both of the right and left sides of the screen display unit 12 that is formed flat, and the mirror portion 21U that is flat is provided on the upper side of the screen display unit 12 so as to be flush with the screen display unit 12. When viewing the screen display unit 12 as being a mirror, the screen display unit 12 and the right and left mirror portions 21L and 21R overall have a form like that of a threefold mirror.

Now, at least the mirror portion 21L on the left side is formed as a one-way mirror, and the camera unit 23 is provided on a rear side thereof as a “sensor unit”. From a user 41, the mirror portion 21L appears to be an ordinary mirror, but the user 41 can be seen from the rear side of the mirror portion 21L. The camera unit 23 is attached to an upper portion, for example, of the mirror portion 21L. The camera unit 23 may be disposed anywhere, as long as a position from which the face of the user 41 and actions of the user 41 can be detected.

The camera unit 23 according to the present embodiment is capable of shooting objects that reflect visible light rays. Alternatively, the camera unit 23 may be an infrared camera. The camera unit 23 may be configured as a combination of a plurality of cameras or sensors. For example, a LiDAR (Light Detection And Ranging) device, an ultrasound sensor, an infrared sensor, or a laser sensor, may be combined with a visible-light camera. An infrared camera and an ordinary visible-light camera may be combined. In a case of combining a plurality of sensor units, one sensor unit and another sensor unit may be installed at different positions. Three or more sensor units may be combined, as well.

The first light portions 22L and 22R are provided on the outer edges of the right and left mirror portions 21L and 21R. In other words, the first light portions 22L and 22R are provided on vertical outer edge portions of the right and left mirror portions 21L and 21R that protrude forward. The first light portions 22L and 22R may be formed as slender rod-like lamps that are elongated, or may be formed by a plurality of small-sized lamps being disposed in a longitudinal direction. It is sufficient for the first light portions 22L and 22R to be able to call the attention of the user 41 and to illuminate the face, hands, and so forth of the user 41, and the type of the lamp and the shape of the lamp are not pertinent.

As illustrated in FIGS. 3 and 4, the right and left mirror portions 21L and 21R are opened from a face of the screen display unit 12 by predetermined angles θ1 and θ2, respectively. The angles θ1 and θ2 may be the same values. As one example, the angles θ1 and θ2 are set within a range of 100 to 175 degrees. The angles θ1 and θ2 are set in a range of 100 to 175 degrees as an example of an angle by which the user 41 can easily visually confirm him/herself from three sides, and also confirm the presence of a suspicious person (third party) 42 who is present behind. Preferably, the angles θ1 and θ2 are set in a range of 120 to 170 degrees, and even more preferably in a range of 150 to 170 degrees. Any angle will suffice as long as an angle that enables the user 41 to check his/her own appearance, and also to confirm the presence of a suspicious person 42 behind him/herself. Being able to confirm the presence of the suspicious person 42 only needs the user 41 to be capable of detecting the presence of the suspicious person 42, and the face of the suspicious person 42 does not have to be visible. The user 41 can detect the presence of the suspicious person 42 even when only a part of the body of the suspicious person 42 is visible in the mirror portions 21L and 21R.

Now, the suspicious person 42 can be detected by a plurality of methods. As one method, a person who comes close to and stands behind the user 41 may be detected as being a suspicious person. As another method, persons may be extracted from image data (video data) shot by the camera unit 23, and whether a questionable person or not can be distinguished by analyzing the posture and behavior of the persons that are extracted. Now, the “questionable person” here includes not only one or a plurality of suspicious persons 42 standing behind the user 41, but the user 41 him/herself as well. As yet another method, the ATM 1 can identify a person from the posture and actions of that person, and can also determine that the person who is identified is a questionable person, if registered in a databased list of questionable persons, which is omitted from illustration.

In this way, in a case in which a person extracted from the video of the camera unit 23 takes a questionable posture or behavior, or in a case in which the person extracted therefrom is identified to be a questionable person, the ATM 1 can display the face of that person on the screen display unit 12, light up one or both of the first light portions 22L and 22R, or the like, which will be described later.

More specifically, the ATM 1 can have motion-capture functions, for example. The ATM 1 can express the user 41 and the suspicious person 42 in the video data by digitizing, as a wire-frame model or the like, and can detect the posture and actions from digital data thereof. The ATM 1 can distinguish whether the posture or behavior are questionable by using a machine learning model. For example, in a case in which the user 41 is trying to operate the screen display unit 12 while using a smartphone, squatting in front of the ATM 1 or glancing around, or the like, the ATM 1 can determine this to be a questionable person. For example, in a case in which a suspicious person (third party) 42 behind the user 41 is taking a posture of looking over the shoulders of the user 41 to peek at the operations being performed by the user 41, the ATM 1 can determine the suspicious person 42 to be a questionable person. While the suspicious person 42 who is trying to peek at PIN number entry operations being performed by the user 41 will be primarily described as being a suspicious person in the description below, the user 41 him/herself may be a questionable person (suspicious person) as well.

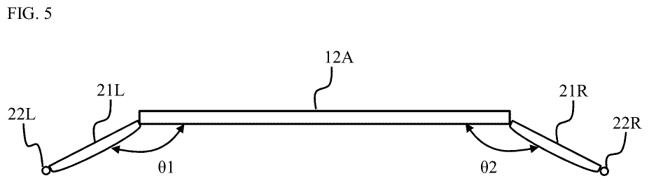

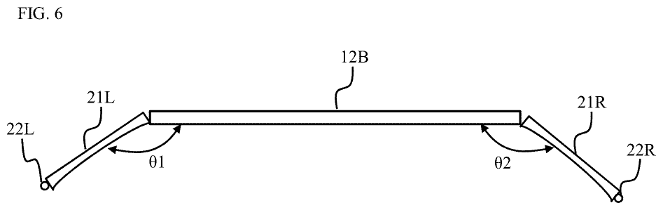

Although the mirror portions 21L and 21R illustrated in FIG. 4 are formed as flat mirrors, the mirror portions 21L and 21R may be formed as convex mirrors, as illustrated in FIG. 5. The mirror portions 21L and 21R may be formed as concave mirrors, as illustrated in FIG. 6.

FIG. 7 is a block diagram illustrating an electrical configuration of the ATM 1. The control unit 10 built into the apparatus main unit 11 is a computer that is equipped with, for example, a processor 101, memory 102, an input/output interface, and a communication interface (both omitted from illustration). A predetermined computer program for functioning as the ATM 1 is stored in the memory 102. Functions of the ATM 1 are realized by the processor 101 reading in and executing the predetermined computer program.

Coupled to the control unit 10 are, for example, the screen display unit 12, the PIN number entry unit 13, the card reader 14, the bill depositing/dispensing unit 15, the non-contact card reader 16, the bill management unit 17, the first light portions 22L and 22R, the camera unit 23, and the communication unit 24. In another embodiment that will be described later, second light portions 32L and 32R are also coupled to the control unit 10. Further, for example, a microphone, a speaker, a printer (all omitted from illustration), and so forth, may be coupled to the control unit 10.

The screen display unit 12 is an apparatus for exchanging information with the user, and is configured as a touchscreen or a monitor display, for example. The screen display unit 12 displays the progress of transaction contents and so forth, messages, and so forth, accepts operation input from the user, and so forth.

The PIN number entry unit 13 is an apparatus for the user to enter a PIN number (PIN: Personal Identification Number) for a bank cash card or the like. The card reader 14 is an apparatus for reading data from the bank cash card or the like. The bill depositing/dispensing unit 15 is an apparatus for depositing and dispensing bills. The non-contact card reader 16 is an apparatus for reading/writing data from/to an IC card or the like, in a non-contact manner. The bill management unit 17 is an apparatus for inspecting and safekeeping bills deposited from the bill depositing/dispensing unit 15, and also for retrieving bills of an instructed monetary amount from a safe, and dispensing the bills from the bill depositing/dispensing unit 15.

The first light portions 22L and 22R realize functions of lamps illuminating the face and the hands of the user, and functions of serving as a warning lamp warning the user to take precautions.

The camera unit 23 is a type of sensor for detecting the presence of users and suspicious persons. The camera unit 23 shoots users and suspicious persons, and sends video data that is shot to the control unit 10. The control unit 10 can display part or all of the video data (image data) shot by the camera unit 23 on the screen display unit 12, as in an embodiment that will be described later.

The communication unit 24 is an apparatus for communicating with a center (omitted from illustration) that manages the ATM 1.

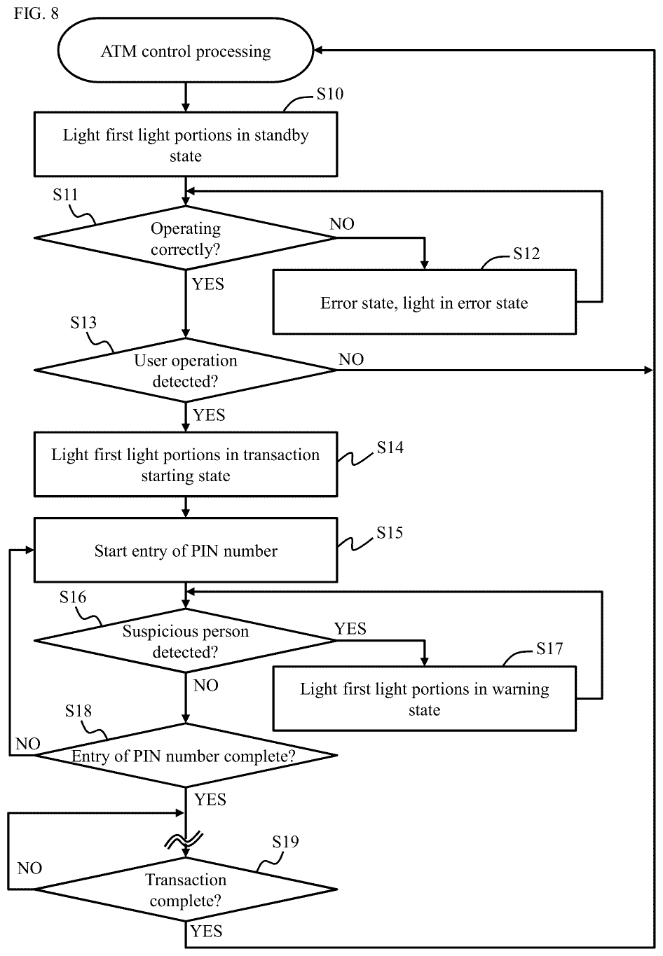

Control processing of the ATM 1 will be described with reference to the flowchart in FIG. 8. In a standby state of the ATM 1 awaiting usage by the user, the first light portions 22L and 22R are lit in a normal color, indicating that the state is the standby state (S10). The normal color may be, for example, a single color such as blue, green, or the like, or may be a plurality of colors combined.

The ATM 1 performs self-diagnosis regarding whether it is operating correctly (S11), and upon detecting that the state is an error state (NO in S11), the first light portions 22L and 22R are lit with an error color, indicating the error state (S12). The error color may be, for example, a single color such as red or the like, or may be a plurality of colors combined.

Upon determining that the results of self-diagnosis are that the ATM 1 is operating correctly (YES in S11), the ATM 1 stands by for operations to be performed by a user (S13). Upon a user operation being detected, such as a user touching the screen display unit 12 or the like (YES in S13), the ATM 1 causes the first light portions 22L and 22R to be lit in a transaction starting state (S14). Causing the first light portions 22L and 22R to be lit in a transaction starting state means, for example, to keep lit in a normal business color such as blue, green, pink, yellow, or the like, to blink in the normal business color, to change a lit range of the normal business color as if flowing from above to below or from below to above, or the like. A plurality of colors may be combined. The ATM 1 can notify the surroundings that a transaction has been started by other methods, as well.

Upon detecting a user operation performed at the PIN number entry unit 13 (S15), the ATM 1 analyzes the video data shot by the camera unit 23, and determines whether a suspicious person is present (S16). Upon detecting a suspicious person (YES in S16), the ATM 1 causes the first light portions 22L and 22R to be lit in a warning state (S17). Causing the first light portions 22L and 22R to be lit in the warning state means to be lit blinking in red or the like, for example. In step S17, the ATM 1 can light the first light portion in a direction in which the suspicious person is detected. For example, in a case in which the suspicious person is detected to the left side of the user, the ATM 1 lights the first light portion 22L on the left side in the warning state. In a case in which the suspicious person is detected to the right side of the user, the ATM 1 lights the first light portion 22R on the right side.

In order to steal a glance of the PIN number of the user, the suspicious person will conceivably show his/her face from either the right side or the left side from behind the user, and accordingly the first light portion of the first light portions 22L and 22R disposed on the side of the direction in which the suspicious person is trying to peek is lit, thereby calling attention of the user. Upon noticing the first light portion that has suddenly started to be lit in the warning state, the user will reflectively move his/her line of sight in that direction. This raises the likelihood of noticing the presence of the suspicious person behind, and accordingly crime prevention capabilities are improved.

The ATM 1 stands by (NO in S18) until entry of the PIN number by the user is completed, and repeats steps S15 to S17. Upon entry of the PIN number by the user being completed (YES in S18), the ATM 1 carries out steps necessary for transactions, such as depositing processing, withdrawal processing, or the like (omitted from illustration), and determines whether the transaction is completed (S19). Upon determining that the transaction is completed (YES in S19), the ATM 1 returns to step S10.

According to the ATM 1 of the present embodiment that is configured in this way, the user can check his/her own appearance by the plurality of mirror portions 21L and 21R disposed adjacent to the periphery of the screen display unit 12, and can also confirm a suspicious person approaching from behind. Further, the mirror portions 21L and 21R can illuminate the user and the surroundings thereof by reflecting light from indoor illumination, and can shoot the face of the user by the camera unit 23 or the like in an illuminated state, thereby improving crime prevention capabilities. Shooting the face of the user in an illuminated environment can be useful for investigation or the like at a later date.

With the ATM 1 according to the present embodiment, the mirror portions 21L and 21R are disposed on the periphery of the screen display unit 12, and also the first light portions 22L and 22R are provided on the outer edges of the mirror portions 21L and 21R, and are lit in accordance with the environment of the apparatus main unit 11. Lighting the first light portions 22L and 22R that are adjacent to the mirror portions 21L and 21R brightly outlines the outer edges of the mirror portions 21L and 21R, and also the light therefrom is reflected at the mirror portions 21L and 21R, such that the surroundings of the screen display unit 12 become bright, and aesthetic appearance is improved. Further, the light from the first light portions 22L and 22R illuminates the user and the surroundings thereof, and accordingly the user and the surroundings thereof can be made to be even brighter. As a result, the user can be shot by the camera unit 23 in a clear manner in an illuminated state, and also erroneous operations by the user that occur in dark environments can be suppressed.

With the ATM 1 according to the present embodiment, the mirror portions 21L and 21R are provided inclined forward by the predetermined angles θ1 and θ2 from the right and left sides of the screen display unit 12, and accordingly the user can check his/her own appearance from the three directions of front, right, and left, and can also use the ATM 1 like a threefold mirror during the transaction at the ATM 1.

The ATM 1 according to the present embodiment lights the first light portions 22L and 22R in accordance with the environment of the ATM 1 such as the standby state of the ATM 1, the state of the ATM 1 starting a transaction, the state of an error occurring at the ATM 1, and a warning state of a suspicious person being detected. Accordingly, the user and people in the surroundings of the ATM 1 can be notified of the current situation of the ATM 1, thereby improving crime prevention capabilities and ease of use. Improving ease of use means not only improving the ease of use for the user, but also improving the ease of use for a manager of the ATM 1, maintenance staff thereof, facility staff, and so forth.

With the ATM 1 according to the present embodiment, the lit state of the first light portion that is closer to a suspicious person who is “another person” is controlled out of the first light portions 22L and 22R, and notifies the user of the presence of the suspicious person, whereby crime by the suspicious person can be proactively prevented, and thus crime prevention capabilities can be improved.

The ATM 1 according to the present embodiment monitors suspicious persons by the camera unit 23, after entry of the PIN number is started (steps S15 and S16 in FIG. 8). Accordingly, the electric power consumption of the camera unit 23 and the control unit 10 can be reduced as compared to a case of monitoring people in the surroundings of the ATM 1 by the camera unit 23 at all times. That is to say, the ATM 1 according to the present embodiment monitors by the camera unit 23 while there is a possibility of someone stealing a glance at information to be protected (e.g., PIN number), thereby efficiently performing monitoring, and crime prevention capabilities can be improved.

### Second Embodiment

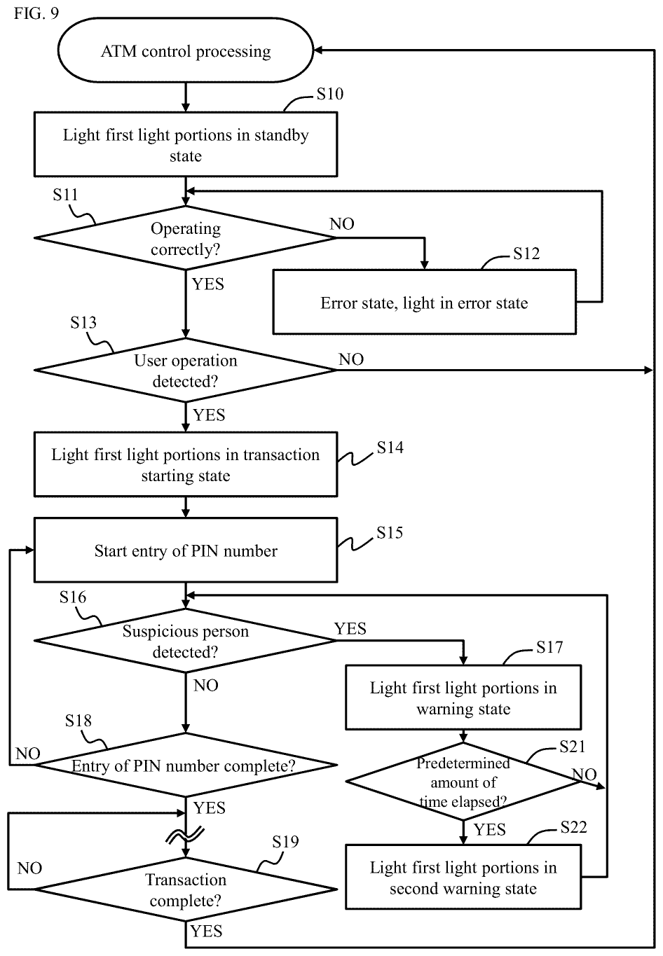

A second embodiment will be described with reference to FIG. 9. In the embodiments below, including the present embodiment, description will be made primarily regarding points of difference as to the preceding embodiments. In the present embodiment, in a case in which the suspicious person remains at the location for a predetermined amount of time or longer after having been detected, a further warning is issued by the first light portions.

Hereinafter, when no distinction is made between the right and left first light portions, these will be referred to as “first light portions 22”.

FIG. 9 illustrates control processing of the ATM 1 according to the present embodiment. After the suspicious person is detected and the first light portions 22 are lit in the warning state (S17), the ATM 1 determines whether the suspicious person is being detected even after a predetermined amount of time elapses (S21). In a case in which the predetermined amount of time elapses after lighting the first light portions 22 in the warning state but the suspicious person is still detected (YES in S21), the ATM 1 lights the first light portions 22 in a second warning state (S22), and returns to step S16. In the drawings, description of a situation in which the suspicious person is being detected even after the predetermined amount of time elapses is abbreviated to “Predetermined amount of time elapsed?”. The first warning state is the warning state in step S17. The second warning state means a warning state with a higher urgency than that of the first warning state. In the second warning state, for example, the rate of blinking of the first light portions 22 is made faster than in the first warning state, the lighting color is changed, or the like.

The present embodiment configured in this way yields the same advantageous effects as those of the first embodiment. Further, with the present embodiment, in a case in which the suspicious person does not leave even after the predetermined amount of time elapsing after lighting the first light portions 22 in the warning state, the first light portions 22 are lit in the second warning state. Accordingly, this can call the attention of the user more strongly, and also warn the people in the surroundings thereof to take precautions, and further give the suspicious person a strong warning. As a result, crime prevention capabilities are improved over the first embodiment.

### Third Embodiment

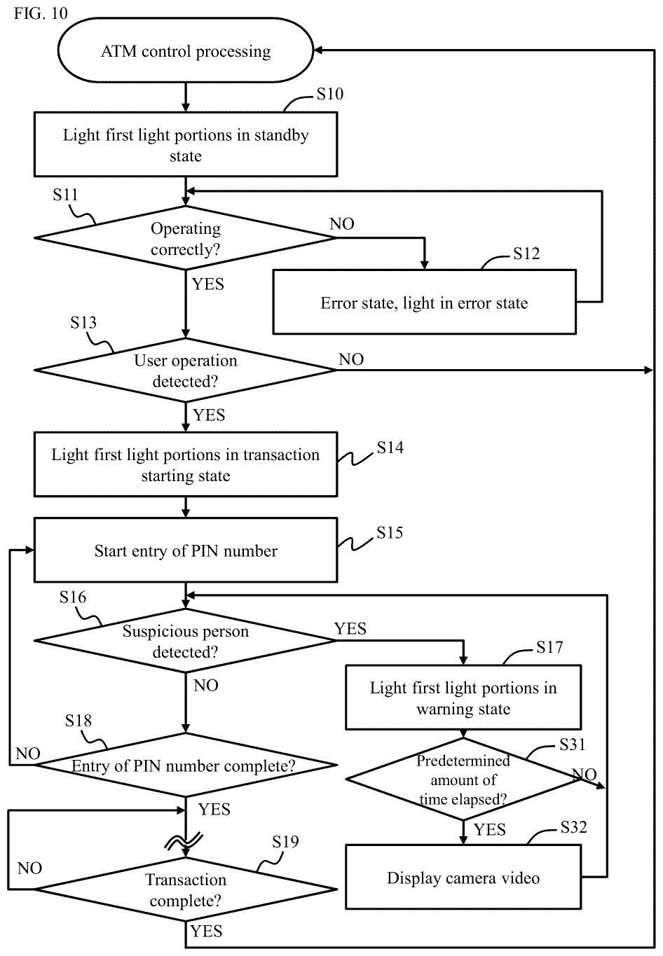

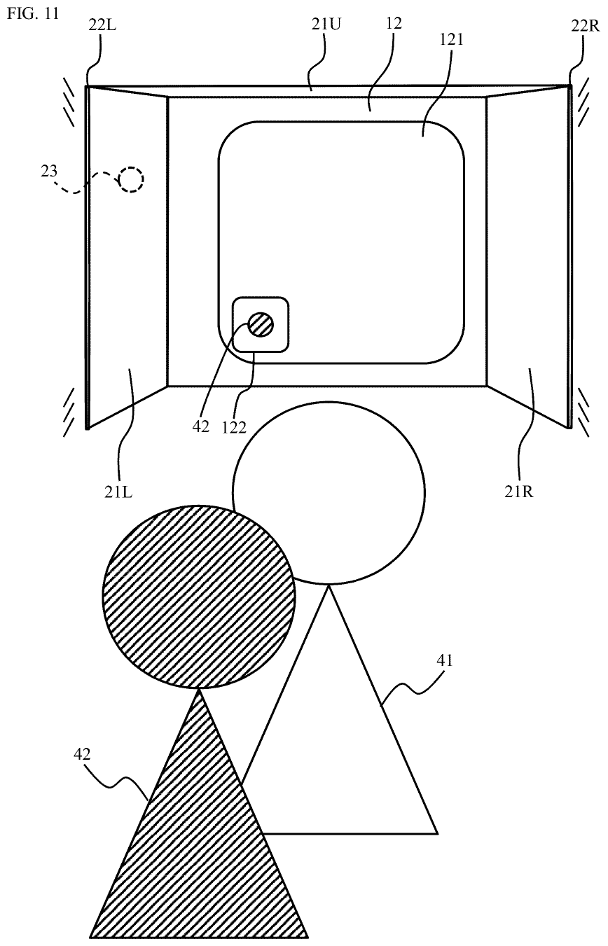

A third embodiment will be described with reference to FIGS. 10 and 11. FIG. 10 illustrates control processing of the ATM 1. In the present embodiment, in a case in which following the first light portions 22 being lit in the warning state (S17), and the predetermined amount of time has elapsed but the suspicious person is still detected (YES in S31), part of all of the video shot by the camera unit 23 is displayed on the screen display unit 12 (S32). Part of the video refers to part of the range shot by the camera unit 23, for example, the portion where the suspicious person is in the video.

FIG. 11 illustrates the way in which the video of the suspicious person 42 shot by the camera unit 23 is displayed on the screen display unit 12. A display area 122 for displaying the video shot by the camera unit 23 is configured in an area of the screen display unit 12 (an area to the lower left in this example). Part or all of the suspicious person is displayed in the display area 122 as part of the video shot by the camera unit 23. The appearance of the user 41 may be displayed along with the suspicious person as well.

The present embodiment configured in this way also yields the same advantageous effects as those of the first embodiment. Further, with the present embodiment, in a case in which the suspicious person does not leave even after lighting the first light portions 22 in the warning state, the video shot by the camera unit 23 is displayed on the screen display unit 12, and accordingly the likelihood of the user noticing the abnormal situation can be raised, and the suspicious person can be strongly warned, as well. When realizing that he/she is being shot, the suspicious person will conceivably leave before engaging in wrongdoing. As a result, crime prevention capabilities of the ATM 1 according to the present embodiment are improved over those of the first and second embodiments.

### Fourth Embodiment

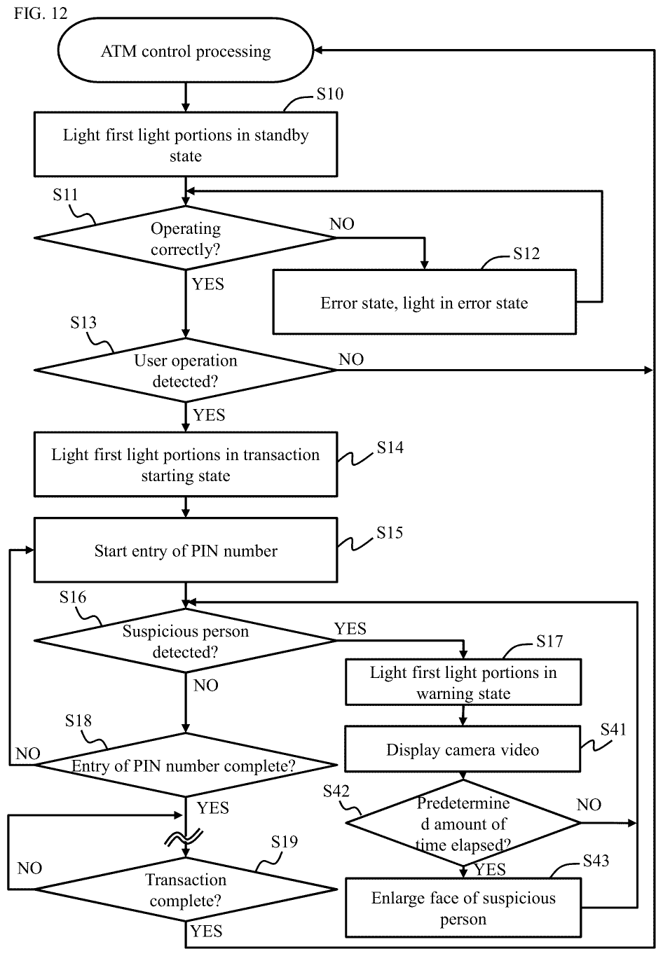

A fourth embodiment will be described with reference to FIG. 12. FIG. 12 illustrates control processing of the ATM 1. In the present embodiment, the first light portions 22 are lit in the warning state (S17), and also the video shot by the camera unit 23 is displayed on the screen display unit 12 (S41). In a case in which the predetermined amount of time has elapsed but the suspicious person is still detected (YES in S42), the ATM 1 displays the face of the suspicious person in the display area 122 in an enlarged manner (S43).

The present embodiment configured in this way also yields the same advantageous effects as those of the first embodiment. Further, with the present embodiment, in a case in which a suspicious person is detected while starting a transaction (YES in S16), the first light portions 22 are lit in the warning state and the video shot by the camera unit 23 is displayed on the screen display unit 12, and accordingly the user can be strongly called to attention, and also the suspicious person can be given an early warning. Further, in a case in which the suspicious person does not leave the vicinity of the ATM 1 even then (YES in S42), the ATM 1 displays in an enlarged manner the face of the suspicious person displayed on the screen display unit 12 (S43). Accordingly, crime prevention capabilities are improved over those of the first, second, and third embodiments.

### Fifth Embodiment

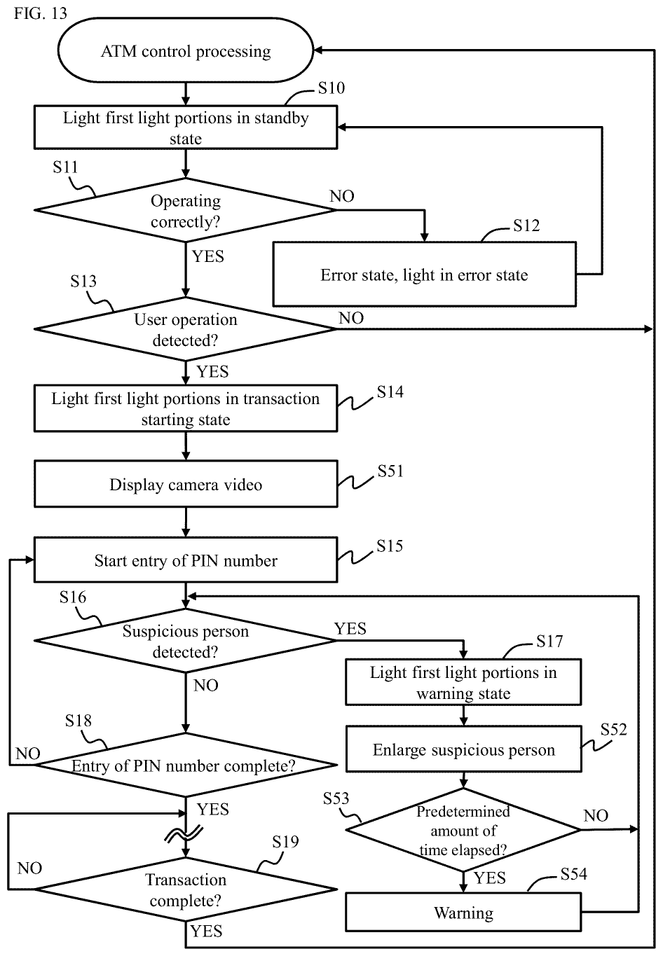

A fifth embodiment will be described with reference to FIG. 13. FIG. 13 illustrates control processing of the ATM 1. In the present embodiment, upon operations being started by the user (YES in S13), the first light portions 22 are lit in the transaction starting state, and further, the video shot by the camera unit 23 is displayed in the display area 122 of the screen display unit 12 (S51). That is to say, the ATM 1 displays the appearance of the user on the screen display unit 12.

Further, upon a suspicious person being detected (YES in S16) and the first light portions 22 being lit in the warning state (S17), the ATM 1 displays the video in which the suspicious person is enlarged in the display area 122 of the screen display unit 12 (S52). In a case in which the predetermined amount of time has elapsed but the suspicious person does not leave (YES in S53), the ATM 1 outputs a warning (S54). The warning here is one or more of sounding a warning buzzer, outputting a warning message such as, for example, “Move away from the ATM”, and transmitting an electronic message to a manager or maintenance staff of the ATM 1, a security guard of the facility, and the police.

The present embodiment configured in this way also yields the same advantageous effects as those of the first embodiment. Further, with the ATM 1 according to the present embodiment, video of the appearance of the user attempting a transaction is displayed on the screen display unit 12 as well, and accordingly the user can be proactively suppressed from performing illegal operations. A user who has intent to perform illegal operations is made to know that he/she is being shot, and accordingly illegal operations can be suppressed from being performed.

Further, the ATM 1 according to the present embodiment lights the first light portions 22 in the warning state (S17), and also displays the video shot of the suspicious person in an enlarged manner on the screen display unit 12 (S52), and in a case in which the suspicious person does not leave even then, outputs a warning (S54). Accordingly, crime prevention capabilities can be improved over those of the first, second, third, and fourth embodiments.

### Sixth Embodiment

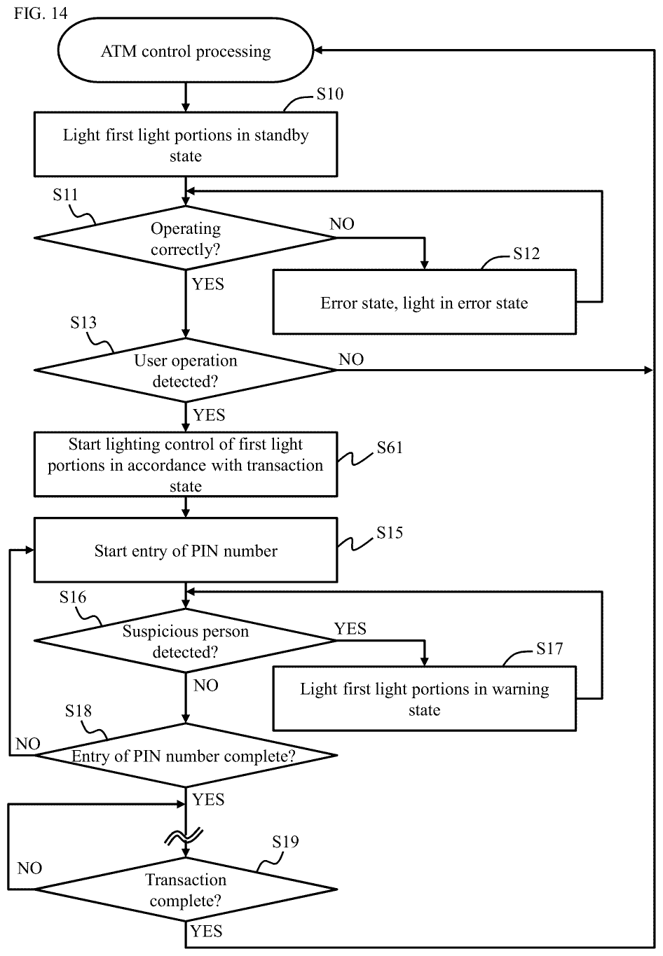

A sixth embodiment will be described with reference to FIG. 14. FIG. 14 illustrates control processing of the ATM 1. In the present embodiment, upon detecting user operations (YES in S13), the ATM 1 controls lighting of the first light portions 22 in accordance with the state of the transaction (S61). In accordance with the state of the transaction includes a meaning of in accordance progress of the transaction. The ATM 1 controls lighting of the first light portions 22 in accordance with the state of the transaction, such as, for example, “Requesting management center for depositing processing”, “Waiting for depositing processing to be completed at management center”, “Depositing processing completed”, and so forth. The range of the first light portions 22 being lit may be broadened as the transaction proceeds, or the lighting color may be changed.

The present embodiment configured in this way also yields the same advantageous effects as those of the first embodiment. Further, the ATM 1 according to the present embodiment controls lighting of the first light portions 22 in accordance with the state of the transaction, and accordingly the aesthetic appearance of the ATM 1 can be improved by the first light portions 22 and the mirror portions 21L and 21R, as well as improving ease of use for the user.

### Seventh Embodiment

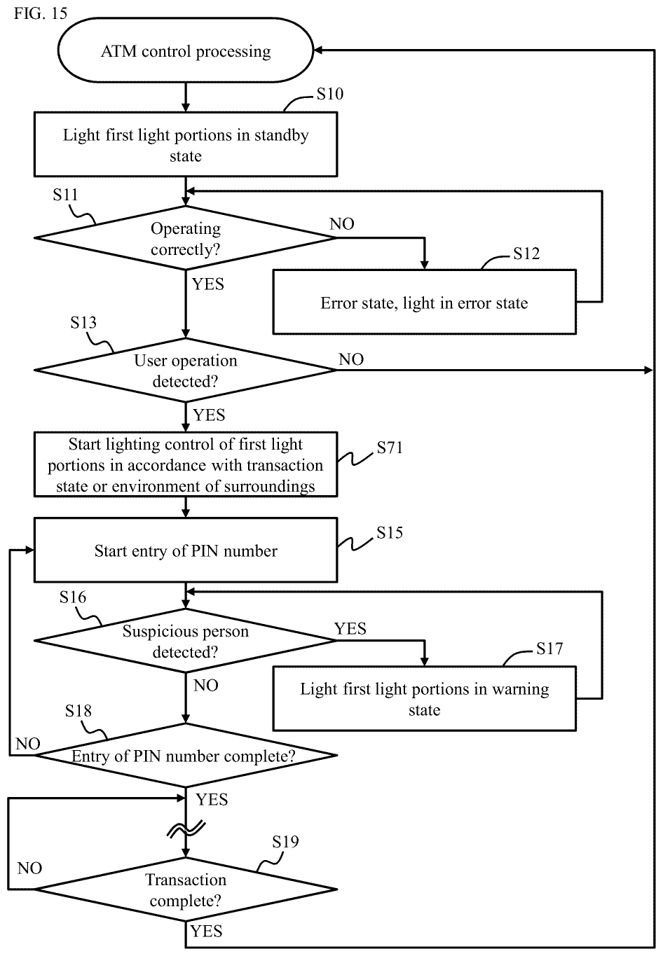

A seventh embodiment will be described with reference to FIG. 15. FIG. 15 illustrates control processing of the ATM 1 according to the present embodiment. Upon user operations being detected (YES in S13), the ATM 1 according to the present embodiment controls lighting of the first light portions 22 in accordance with the state of the transaction and the environment of the surroundings (S71).

The environment of the surroundings as used here is, for example, the weather, outdoor temperature, time, and so forth, at the location where the ATM 1 is installed. By changing the lighting color and the blinking time of the first light portions 22, the ATM 1 can notify the user of the state of the transaction and the environment of the surroundings. Installing a guide chart indicating the relation between the state of the transaction and the environment of the surroundings and the lighting state of the first light portions 22 near the ATM 1 enables the user to know the general situation thereof.

The present embodiment configured in this way also yields the same advantageous effects as those of the first embodiment. Further, in the present embodiment, the user can be notified of the state of the transaction and the environment of the surroundings, further improving the ease of use for the user.

### Eighth Embodiment

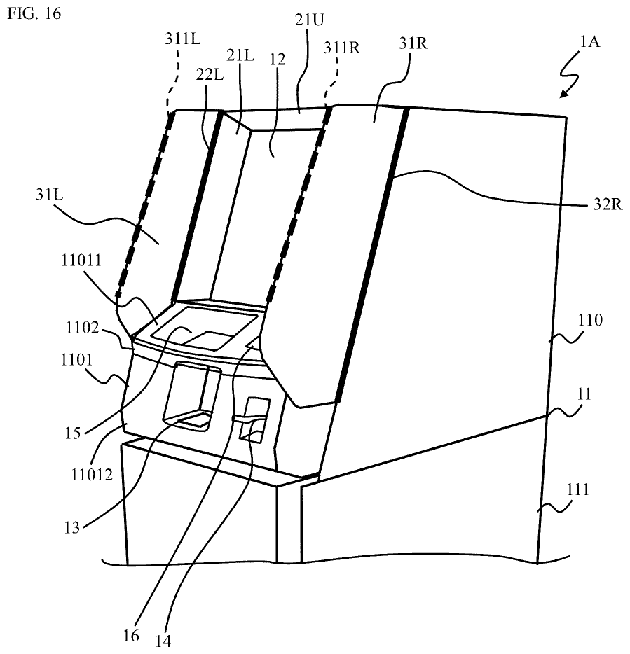

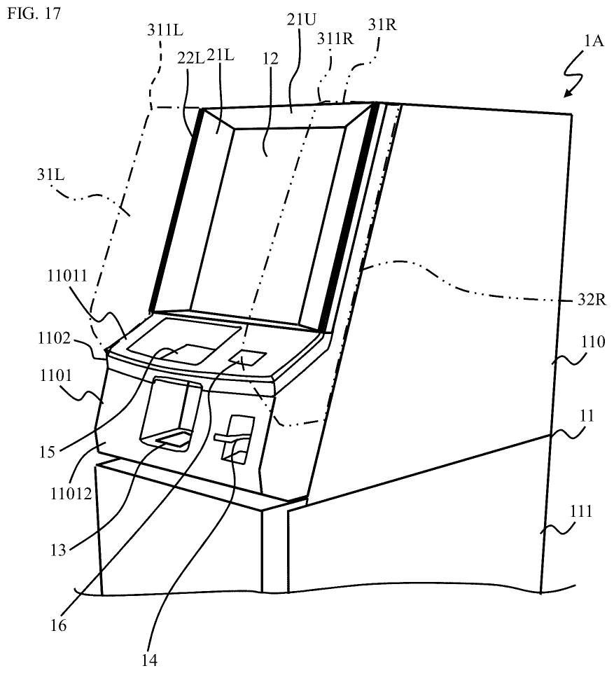

An eighth embodiment will be described with reference to FIGS. 16 and 17. FIG. 16 is an external perspective view illustrating part of an ATM 1A. FIG. 17 is an external perspective view with partition portions 31L and 31R in FIG. 16 removed.

With the ATM 1A according to the present embodiment, the partition portions 31L and 31R are provided on outer sides of the mirror portions 21L and 21R on the right and left sides of the screen display unit 12, and second light portions 32 (only a second light portion 32R on the right side illustrated) that cause at least part of the partition portions 31L and 31R to emit light are provided on the partition portions 31L and 31R. The control unit 10 controls the lit state of the first light portions 22L and 22R, and the lit state of the second light portions 32, in accordance with the environment of the apparatus main unit 11 (ATM 1A).

The partition portions 31L and 31R are provided to prevent external lines of sight and to improve aesthetic appearance, and are disposed adjacent to the mirror portions 21L and 21R, on the outer sides thereof. The second light portions 32 are provided at portions where the partition portions 31L and 31R are attached to the apparatus main unit 11 on the outer sides of the mirror portions 21L and 21R.

Inner portions of the partition portions 31L and 31R are transparent or translucent with regard to visible light rays, for example. Accordingly, light emitted from the second light portions 32 at base portions of the partition portions 31L and 31R migrates while being reflected within the partition portions 31L and 31R, and reaches front end portions 311L and 311R of the partition portions 31L and 31R so as to be diffused to the surroundings therefrom, as illustrated in FIG. 16.

The present embodiment configured in this way also yields the same advantageous effects as those of the first embodiment. Further, with the ATM 1A according to the present embodiment, the partition portions 31L and 31R are provided adjacent to the mirror portions 21L and 21R on the outer sides thereof, and accordingly the aesthetic appearance of the ATM 1A is improved, while also preventing those who would steal a glance from doing so. Further, the partition portions 31L and 31R give a sense of a private booth that is isolated from the surroundings, facilitating use as a threefold mirror, thereby further improving ease of use for the user.

Further, with the ATM 1A, the second light portions 32 are disposed at the base portions of the partition portions 31L and 31R, whereby the length of wiring such as lead wires and so forth can be shortened, ease of assembly of the ATM 1A is improved, and manufacturing costs can be reduced.

Note that the ATM 1A according to the present embodiment can control lighting of the second light portions 32 in the same way as the ATM 1 described by way of the first through seventh embodiments. That is to say, the control unit 10 may perform lighting control of the first light portions 22 and the second light portions 32 in a synchronized manner. In this case, the “Light first light portions in standby state” in FIG. 8, for example, is changed to “Light first light portions and second light portions in standby state”. In the same way, “Light first light portions in transaction starting state” is changed to “Light first light portions and second light portions in transaction starting state”. In the same way, “Light first light portions in warning state” is changed to “Light first light portions and second light portions in warning state”. Other description are the same.

Although the first light portions 22 and the second light portions 32 can be lit synchronously, the lighting color or the blinking rate thereof may be different. The lighting control of the first light portions 22 and the lighting control of the second light portions 32 may be asynchronous. That is to say, the lighting color, the blinking time, and so forth of the second light portions 32 may be unchanged and be constant. Conversely, lighting of the second light portions 32 may be controlled as described in the first to eighth embodiments, and the lighting of the first light portions 22 may be constant.

### Ninth Embodiment

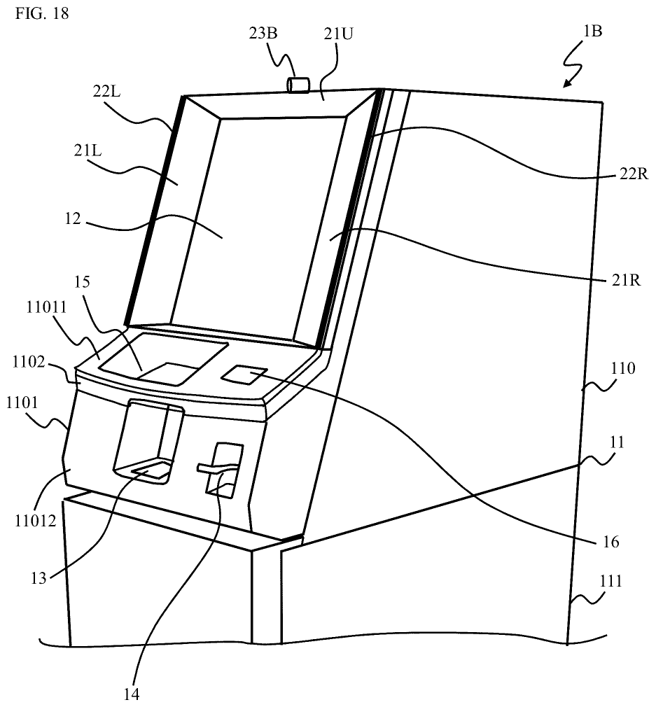

A ninth embodiment will be described with reference to FIG. 18. FIG. 18 is an external perspective view illustrating part of an ATM 1B according to the present embodiment. In the ATM 1B according to the present embodiment, a camera unit 23B is installed not on the rear side of the mirror portions 21 but outside of the mirror portions 21. For example, the camera unit 23B is attached to the upper portion of the apparatus main unit 11, so as to be situated on the upper side of the screen display unit 12. In this case, there is no need for the mirror portions 21 to be one-way mirrors, and can be formed as normal mirrors.

The present embodiment configured in this way also yields the same advantageous effects as those of the first embodiment. Further, with the present embodiment, the camera unit 23B is disposed not on the rear side of the mirror portions 21 but on the outer side thereof, and accordingly the structure can be simplified, thereby enabling manufacturing costs to be reduced.

### Tenth Embodiment

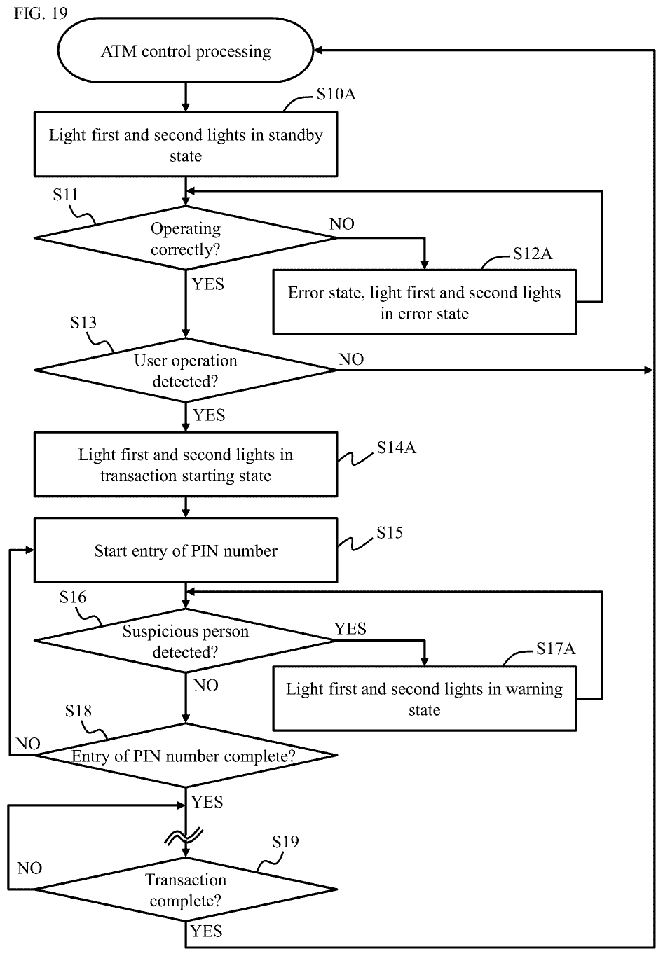

A tenth embodiment will be described with reference to FIG. 19. FIG. 19 shows control processing of the ATM 1 according to the present embodiment. In the present embodiment, the control unit 10 lights the first light portions 22 and the second light portions 32 collaboratively (synchronously), which has been described in the eighth embodiment. That is to say, the control unit 10 can light the first light portions 22 and the second light portions 32 in a synchronized manner in the standby state (S10A), the error state (S12A), the transaction starting state (S14A), and the warning state (S17A). The first light portions 22 and the second light portions 32 may be synchronously controlled in at least one of the steps S10A, S12A, S14A, and S17A. The present embodiment configured in this way also yields the same advantageous effects as the first embodiment.

### Eleventh Embodiment

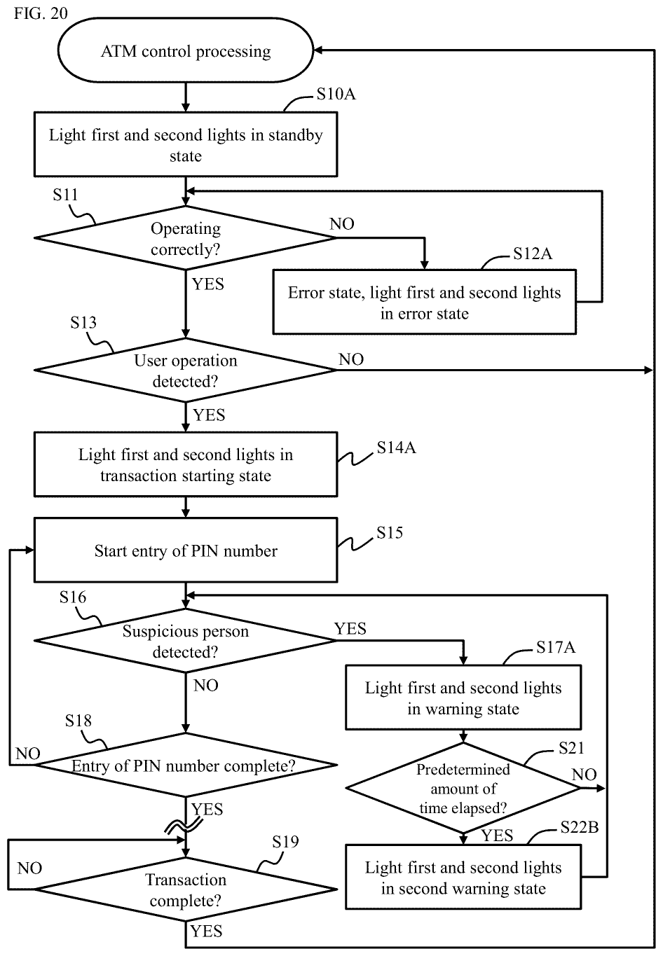

An eleventh embodiment will be described with reference to FIG. 20. FIG. 20 shows control processing of the ATM 1 according to the present embodiment. With the ATM 1 according to the present embodiment, the first light portions 22 and the second light portions 32 are lit synchronously, not only in the standby state (S10A), the error state (S12A), the transaction starting state (S14A), and the first warning state (S17A), but also in the second warning state (S22B). The present embodiment configured in this way also yields the same advantageous effects as the first embodiment.

### Twelfth Embodiment

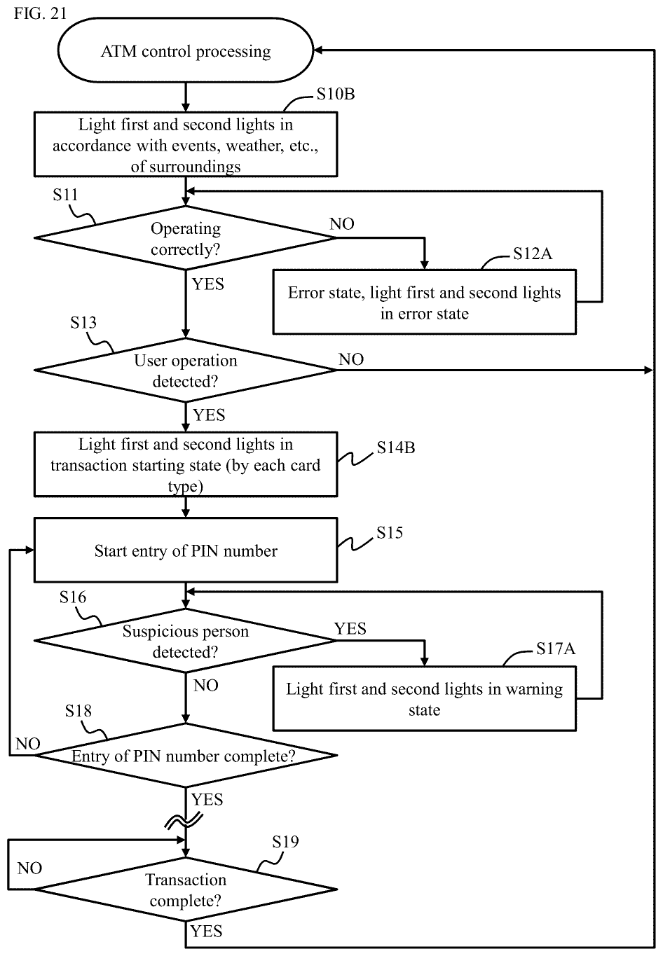

A twelfth embodiment will be described with reference to FIG. 21. FIG. 21 shows control processing of the ATM 1 according to the present embodiment. With the ATM 1 according to the present embodiment, the first light portions 22 and the second light portions 32 are lit synchronously in the standby state, in accordance with events or weather of the surroundings (S10B), in contrast with the processing described with reference to FIG. 19. Further, the control unit 10 of the ATM 1 according to the present embodiment controls lighting of the first light portions 22 and the second light portions 32 in the transaction starting state in accordance with the type of bank cash card used by the user (S14B). The lighting color of the first light portions 22 and the second light portions 32 can be controlled in accordance with a bank theme color, for example. In a case in which the bank theme color is a plurality of colors, the lighting color of the first light portions 22 and the lighting color of the second light portions 32 can be combined to reproduce the bank theme color. The present embodiment configured in this way also yields the same advantageous effects as the first embodiment.

Note that the present embodiment is not limited to the above-described embodiments, and various modifications are included. For example, the above-described embodiments are detailed descriptions made to facilitate understanding of the present embodiment, and are not necessarily limited to arrangements including all of the configurations that are described. Also, part of the configurations of one embodiment can be replaced with the configurations of another and also, embodiment, the configurations of one embodiment can be added to the configurations of another embodiment. Also, with respect to part of the configurations of the embodiments, other configurations can be added, configurations can be omitted, and configurations can be substituted. Also, information such as programs, tables, files, and so forth, for realizing the configurations, may reside on memory, recording apparatuses such as a hard disk, an SSD (Solid State Drive), or the like, or a recording medium such as an IC card, an SD card, a DVD, or the like.

Inventions that are expressed as follows are disclosed in the above-described present embodiment.

(Expression 1) An automated teller machine, including an apparatus main unit, a screen display unit that is provided to the apparatus main unit, a plurality of mirror portions that are provided on a periphery of the screen display unit, a first light portion that is provided in a predetermined area of an outer edge of each of the mirror portions, and a control unit that is provided to the apparatus main unit, in which the control unit is configured to control lighting of the first light portion in accordance with an environment of the apparatus main unit.

(Expression 2) The automated teller machine according to Expression 1, in which the plurality of mirror portions are mirror portions provided on both right and left sides of the screen display unit.

(Expression 3) The automated teller machine according to Expression 1 or 2, in which the plurality of mirror portions are mirror portions provided on both right and left sides of the screen display unit and on an upper side of the screen display unit.

(Expression 4) The automated teller machine according to any one of Expressions 1 to 3, in which the plurality of mirror portions are provided inclining forward at a predetermined angle from both right and left sides of the screen display unit.

(Expression 5) The automated teller machine according to any one of Expressions 1 to 4, in which a sensor unit that is configured to detect an object on the screen display unit side of the apparatus main unit is further provided to the apparatus main unit.

(Expression 6) The automated teller machine according to any one of Expressions 1 to 5, in which at least one of the plurality of mirror portions is a one-way mirror portion, and the sensor unit that is configured to detect the object on the screen display unit side is provided on a rear side of at least one of the one-way mirror portions.

(Expression 7) The automated teller machine according to any one of Expressions 1 to 6, in which the environment of the apparatus main unit is a usage environment of the apparatus main unit being used by a user.

(Expression 8) The automated teller machine according to any one of Expressions 1 to 7, in which as a usage environment of the apparatus main unit, in a case in which another person different from a user operating the apparatus main unit is detected by the sensor unit, the control unit controls, out of the first light portions, a lighting state of a first light portion that is closer to the other person, to perform notification regarding presence of the other person.

(Expression 9) The automated teller machine according to any one of Expressions 1 to 8, in which the sensor unit is a camera unit that is configured to shoot the object, and the control unit is configured to display an image shot by the camera unit on the screen display unit.

(Expression 10) The automated teller machine according to any one of Expressions 1 to 9, in which the sensor unit is a camera unit that is configured to shoot the object, and the control unit is configured to display, out of images shot by the camera unit, an image of the other person, on the screen display unit.

(Expression 11) The automated teller machine according to any one of Expressions 1 to 10, in which a partition portion is provided on an outer side of the mirror portions on both right and left sides of the screen display unit, a second light portion that is configured to cause at least part of each of the partition portions to emit light is provided to each of the partition portions, and the control unit is configured to control a lighting state of the first light portion and a lighting state of the second light portion in accordance with the environment of the apparatus main unit.

(Expression 12) The automated teller machine according to any one of Expressions 1 to 11, in which the environment of the apparatus main unit is at least one of an operation state of the apparatus main unit, a progress state of a transaction at the apparatus main unit, a type of financial transaction card used at the apparatus main unit, temperature of surroundings of the apparatus main unit, weather of a location where the apparatus main unit is installed, and an even associated with the location where the apparatus main unit is installed.

(Expression 13) The automated teller machine according to any one of Expressions 1 to 12, in which the apparatus main unit further includes a bill depositing/dispensing unit that is configured to perform depositing and dispensing of bills, and a PIN number entry unit that is lower side situated on a of the bill depositing/dispensing unit and that is configured to receive entry of a PIN number, and a stepped portion is provided between the PIN number entry unit and the bill depositing/dispensing unit.

What is claimed is:

1. An automated teller machine, comprising:
an apparatus main unit;
a screen display unit that is provided to the apparatus main unit;
a plurality of mirror portions that are provided on a periphery of the screen display unit;
a first light portion that is provided in a predetermined area of an outer edge of each of the mirror portions; and
a control unit that is provided to the apparatus main unit, wherein
the control unit is configured to control lighting of the first light portion in accordance with an environment of the apparatus main unit.

2. The automated teller machine according to claim 1, wherein
the plurality of mirror portions are mirror portions provided on both right and left sides of the screen display unit.

3. The automated teller machine according to claim 1, wherein
the plurality of mirror portions are mirror portions provided on both right and left sides of the screen display unit and on an upper side of the screen display unit.

4. The automated teller machine according to claim 2, wherein
the plurality of mirror portions are provided inclining forward at a predetermined angle from both right and left sides of the screen display unit.

5. The automated teller machine according to claim 4, wherein
a sensor unit that is configured to detect an object on the screen display unit side of the apparatus main unit is further provided to the apparatus main unit.

6. The automated teller machine according to claim 5, wherein
at least one of the plurality of mirror portions is a one-way mirror portion, and the sensor unit that is configured to detect the object on the screen display unit side is provided on a rear side of at least one of the one-way mirror portions.

7. The automated teller machine according to claim 5, wherein
the environment of the apparatus main unit is a usage environment of the apparatus main unit being used by a user.

8. The automated teller machine according to claim 5, wherein
as a usage environment of the apparatus main unit, in a case in which another person different from a user operating the apparatus main unit is detected by the sensor unit, the control unit controls, out of the first light portions, a lighting state of a first light portion that is closer to the other person, to perform notification regarding presence of the other person.

9. The automated teller machine according to claim 5, wherein
the sensor unit is a camera unit that is configured to shoot the object, and
the control unit is configured to display an image shot by the camera unit on the screen display unit.

10. The automated teller machine according to claim 8, wherein
the sensor unit is a camera unit that is configured to shoot the object, and
the control unit is configured to display, out of images shot by the camera unit, an image of the other person, on the screen display unit.

11. The automated teller machine according to claim 1, wherein
a partition portion is provided on an outer side of the mirror portions on both right and left sides of the screen display unit,
a second light portion that is configured to cause at least part of each of the partition portions to emit light is provided to each of the partition portions, and
the control unit is configured to control a lighting state of the first light portion and a lighting state of the second light portion in accordance with the environment of the apparatus main unit.

12. The automated teller machine according to claim 1, wherein
the environment of the apparatus main unit is at least one of an operation state of the apparatus main unit, a progress state of a transaction at the apparatus main unit, a type of financial transaction card used at the apparatus main unit, temperature of surroundings of the apparatus main unit, weather of a location where the apparatus main unit is installed, and an even associated with the location where the apparatus main unit is installed.

13. The automated teller machine according to claim 1, wherein
the apparatus main unit further includes a bill depositing/dispensing unit that is configured to perform depositing and dispensing of bills, and a PIN number entry unit that is situated on a lower side of the bill depositing/dispensing unit and that is configured to receive entry of a PIN number, and
a stepped portion is provided between the PIN number entry unit and the bill depositing/dispensing unit.
